(19) United States
(12) Patent Application Publication
(10) Pub. No.: US 2006/0040520 A1
(43) Pub. Date: Feb. 23, 2006

(54) Flat panel display device including a conductive compressible body

(75) Inventor: Sang-Moon Moh, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/208,101

(22) Filed: Aug. 18, 2005

(30) Foreign Application Priority Data
Aug. 19, 2004 (KR) 10-2004-65329

(51) Int. Cl. H01R 12/00

(52) U.S. Cl. 439/66

(57) ABSTRACT

The flat panel display includes a receiving unit, a substrate and a conductive compressible body. The receiving unit receives a flat panel. The substrate has a driving circuit that applies a signal to the flat panel to display an image. The conductive compressible body electrically connects a ground pattern of the substrate to the receiving unit. Therefore, a conductive compressible body for electrically connecting is between the ground pattern of the driving circuit unit and the top chassis, so that noise and EMI are shielded.

### CROSS-REFERENCE TO RELATED APPLICATION

This application relies for priority upon Korean Patent Application No. 2004-65329 filed on Aug. 19, 2004, the content of which is herein incorporated by reference in its entirety.

### BACKGROUND OF THE INVENTION

1. Field of the Invention

The present invention relates to a flat panel display device, and more particularly to a flat panel display device capable of decreasing noise and electromagnetic interference (EMI).

2. Description of the Related Art

Generally, a packaging method of a thin film transistor-liquid crystal display (TFT-LCD) module is classified into a tape automated bonding (TAB) packaging method and a chip on glass (COG) packaging method. Of the two methods, the latter packaging method has been developed to package a large-screen LCD panel. More particularly, the COG packaging method has been developed with the goal of decreasing the package size and a manufacturing cost.

In the TAB packaging method, a TAB integrated circuit (IC) is electrically connected to an LCD panel and a printed circuit board (PCB). The LCD panel has a smaller pitch than the PCB. In addition, the LCD panel includes glass and metal. An anisotropic conductive film (ACF) connects the TAB IC to the LCD panel, and the TAB IC is electrically connected to the PCB through a soldering process.

A ground pattern of the PCB makes contact with the chassis, thereby shielding noise and electromagnetic interference (EMI) generated from the PCB, the TAB IC, the LCD panel, etc. and stabilizing the operation of the LCD device. In particular, a high voltage that is generated from the backlight assembly is applied to the chassis so that the voltage level of the chassis is changed by the high voltage generated from the backlight assembly. However, the chassis is electrically connected to the ground pattern of the PCB to stabilize the voltage level of the chassis. Thus, the chassis is simultaneously subjected to the high voltage generated from the backlight assembly and ground voltage.

A main body having the chassis is electrically connected to a ground potential through the ground pattern of the PCB so that noise and EMI are decreased. The backlight assembly is electrically connected to the chassis through a clip, and the clip is electrically connected to the ground pattern of the PCB through a screw so that the chassis is electrically connected to the ground potential. Although this configuration achieves the desired electrical connections, electrically connecting the chip to the ground pattern through the screw complicates the fabricating process of the LCD device.

In order to simplify the fabricating process, attempts have been made to replace the screw with a conductive tape. The conductive tape is attached to a PCB cover to electrically connect the ground pattern of the PCB to the chassis. While this conductive tape configuration works for larger LCD modules, the clip for a small-screen LCD module manufactured by the COG module is too small to work reliably with the conductive tape. Thus, small-screen LCD module still requires the screw.

Further, the fabricating process using the conductive tape is not without problems. In such processes, the conductive tape is attached to the PCB cover, eliminating the screw from the LCD module. Usually, the conductive tape (such as an aluminum tape) is interposed between the ground pattern of the PCB and the chassis. However, the contact characteristics between the ground pattern of the PCB and the chassis are often deteriorated because the conductive tape becomes partially detached from the ground pattern.

A method of grounding the chassis without the above limitations is desired.

### SUMMARY OF THE INVENTION

The present invention provides a flat panel display device capable of decreasing noise and EMI.

In an aspect of the present invention, a flat panel display includes a receiving unit, a substrate and a conductive compressible body. The receiving unit receives a flat panel. The substrate has a ground pattern and a driving circuit that applies a signal to the flat panel to display an image. The conductive compressible body electrically connects the ground pattern of the substrate to the receiving unit.

The conductive compressible body may be a gasket that includes conductive particles and a conductive material that is coated on the conductive particles. The substrate may include a base film and a plurality of conductive paths that are formed on the base film, and the ground pattern is exposed so that the ground pattern is electrically connected to the conductive compressible body. The signal to display the image includes a data signal, a clock signal and a power voltage, and the conductive paths may include a data line transferring the data signal, a clock line transferring the clock signal, and a voltage line transferring the power voltage. The ground pattern that is electrically insulated from the data line, the clock line and the voltage line may be formed from a same layer as the data line, the clock line and the voltage line.

The flat panel display device may further include a conductive adhesive layer between the receiving unit and the conductive compressible body. The widest surface of the conductive compressible body is on the flat panel and an upper surface of the receiving unit. The widest surface of the conductive compressible body may also be on an inner surface of the receiving unit.

In another aspect of the present invention, a flat panel display includes a flat panel, a first receiving unit, a substrate and a conductive compressible body. The flat panel displays an image. The first receiving unit receives the flat panel. The substrate has a driving circuit that applies a signal to the flat panel to display the image. The conductive compressible body electrically connects a ground pattern of the substrate to the first receiving unit.

In still another aspect of the present invention, a flat panel display includes a flat panel, a receiving unit, a driving circuit, and a conductive compressible body. The flat panel has an effective display area and a peripheral area. The receiving unit receives the flat panel. The driving circuit formed on the peripheral area applies a signal for displaying an image to the effective display area through a conductive path. The conductive compressible body electrically connects a ground pattern formed on the peripheral area to the first receiving unit.

The flat panel has an effective display area and a peripheral area. The receiving unit receives the flat panel. The driving circuit is formed on the peripheral area for providing a signal to display an image to the effective display area through a conductive path. The conductive compressible body electrically connects to a ground pattern formed on the peripheral area and the first receiving unit.

According to the flat panel display device, a conductive compressible body for electrically connecting the ground pattern of the driving circuit unit to the top chassis is introduced, so that noise and EMI are decreased.

### BRIEF DESCRIPTION OF THE DRAWINGS

The above and other advantages of the present invention will become more apparent by describing in detail embodiments thereof with reference to the accompanying drawings, in which:

FIG. 1 is an exploded perspective view showing a flat panel display device according to a first embodiment of the present invention;

FIG. 2 is an enlarged cross-sectional view showing the flat panel display device of FIG. 1;

FIG. 3 is a partially cut out enlarged perspective view showing the flat panel display device of FIG. 1;

FIG. 4 is an exploded perspective view showing a conductive compressible body disposed between a panel assembly and a top chassis of the flat panel display device of FIG. 1;

FIG. 5 is a plan view showing a conductive compressible body that makes contact with a ground pattern of a flexible printed circuit board (FPCB) of the flat panel display device of FIG. 1;

FIG. 6 is a partially cut out perspective view showing a conductive compressible body that is attached to the top chassis of FIG. 4;

FIG. 7 is an exploded perspective view showing a flat panel display device according to a second embodiment of the present invention;

FIG. 8 is a plan view showing a plurality of conductive patterns formed on the array substrate and a ground pattern of FIG. 7;

FIG. 9 is an exploded perspective view showing a conductive compressible body disposed between a panel assembly and a top chassis of FIG. 7; and

FIG. 10 is a partially cut out perspective view showing a conductive compressible body that is attached to the top chassis of FIG. 9.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations are expected due to, for example, imprecise manufacturing techniques and/or tolerances. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

### Embodiment 1

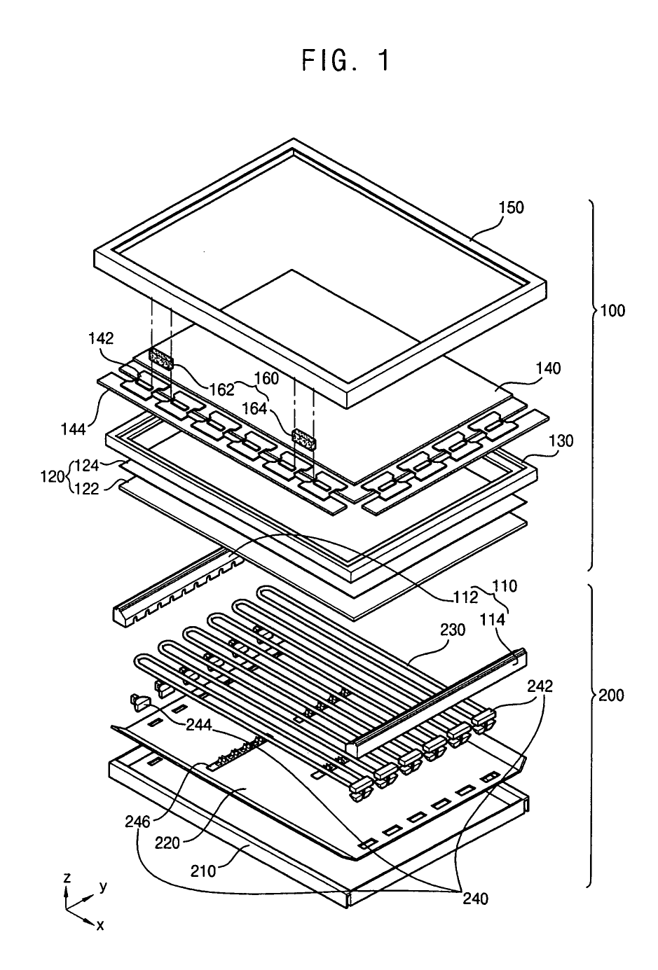

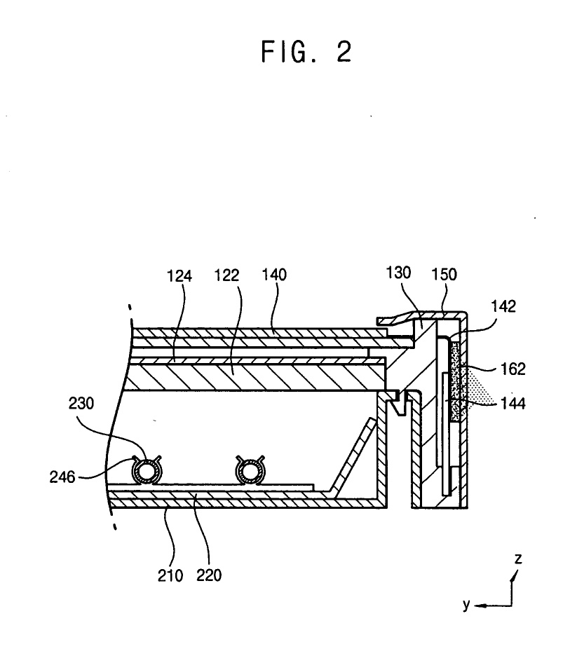

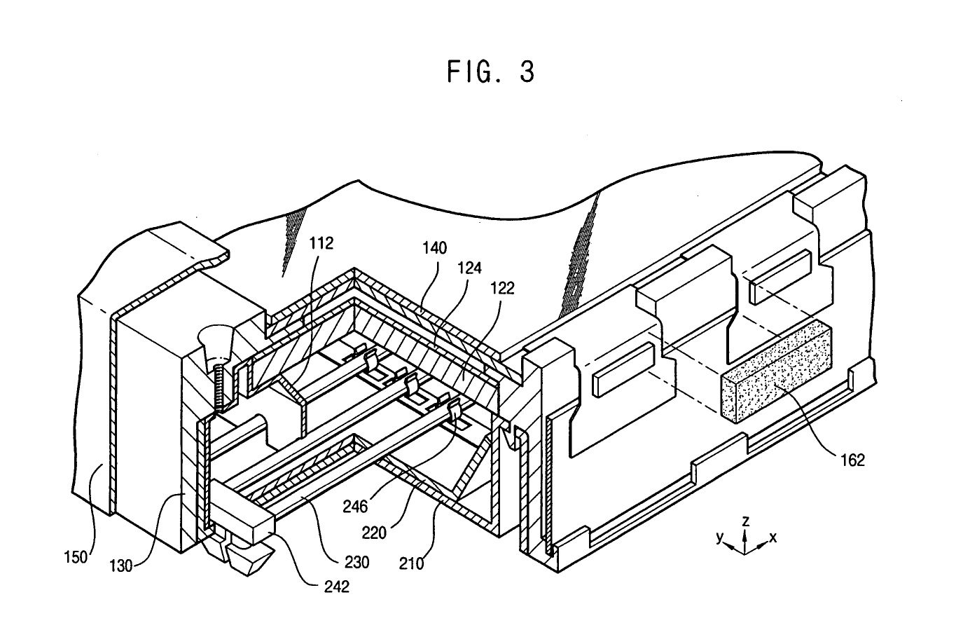

FIG. 1 is an exploded perspective view showing a flat panel display device according to a first embodiment of the present invention. FIG. 2 is an enlarged cross-sectional view showing the flat panel display device of FIG. 1. FIG. 3 is a partially cut out enlarged perspective view showing the flat panel display device of FIG. 1.

Referring to FIGS. 1 to 3, the flat panel display device includes a display panel assembly 100 in an upper portion of the flat panel display device and a backlight assembly 200 in a lower portion of the flat panel display device.

The display panel assembly 100 includes a side mold unit 110, a brightness enhancing unit 120, an upper mold 130, a flat panel 140, a top chassis 150 and a conductive compressible body 160, and receives the light emitted from the backlight assembly 200 to display an image.

The side mold unit 110 includes a first side mold 112 and a second side mold 114. The side mold unit 110 guides the backlight assembly 200 and supports the brightness enhancing unit 120. The first and second side molds 112 and 114 guide the lamps through a plurality of holes formed in a lower portion of the first and second side molds 112 and 114, and support the brightness enhancing unit 120 through a stepped portion formed on an upper part of the first and second side molds 112 and 114.

The brightness enhancing unit 120 includes a diffusion plate 122 and optical sheets 124 formed on the diffusion plate 122. The brightness enhancing unit 120 is on the side mold unit 110. The brightness enhancing unit 120 uniformizes the brightness of the light that is generated from the backlight assembly 200, and outputs the light having a uniform brightness distribution toward the flat panel 140. The diffusion plate 122 and the optical sheets 124 are on a stepped portion formed on the first side mold 112 and a stepped portion formed on the second side mold 114.

The upper mold 130 is shaped like a frame and supports an edge of the flat panel 140. The upper mold 130 receives the flat panel 140. The upper mold 130 is combined with the side mold unit 110 to prevent drifting of the brightness enhancing unit 120 that includes the diffusion plate 122 and the optical sheets 124 on the diffusion plate 122. The optical sheets 124 may include a diffusion sheet, prism sheets, a protective sheet, etc.

The flat panel 140 includes substrates and a liquid crystal layer between the substrates. The flat panel 140 is on the upper mold 130 and receives the light emitted from the backlight assembly 200 to display an image using electric and optical characteristics of a liquid crystal of the liquid crystal layer.

The flat panel 140 is electrically connected to a printed circuit board (PCB) 144 through a flexible printed circuit board (FPCB) 142. A tape automated bonding integrated circuit (TAB IC) is formed on the FPCB 142. Conductive paths and ground patterns are formed on a peripheral area of the TAB IC. The conductive paths are electrically connected to a lead bonding of the TAB IC. The lead bonding of the TAB IC is in the peripheral area. A conductive compressible body 160 is on the ground pattern.

The flat panel 140 includes an array substrate having a plurality of gate lines, a plurality of data lines, and a thin film transistor that is electrically connected to one of the gate lines and one of the data lines. A gate pad that is formed at end portions of the gate lines is electrically connected to a conductive path of the FPCB 142.

The top chassis 150 that is shaped like a frame is combined with the upper mold 130 to prevent the drifting of the flat panel 140.

The conductive compressible body 160 includes a first gasket 162 and a second gasket 164, and electrically connects the ground pattern formed on the FPCB 142 to the top chassis 150. Each of the first and second gaskets 162 and 164 includes a conductive material that is coated on a surface of each of the first and second gaskets 162 and 164. The first and second gaskets 162, 164 are compressible like a sponge.

The backlight assembly 220 includes a bottom chassis 210, a reflecting plate 220, a lamp 230 and a lamp guide unit 240, and the light generated from the backlight assembly 220 is irradiated onto the brightness enhancing unit 120 of the display panel assembly 100.

The bottom chassis 210 has a bottom plate and a plurality of sidewalls protruding from sides of the bottom plate. The bottom chassis 210 receives the reflecting plate 220, the lamp 230 and the lamp guide unit 240.

The reflecting plate 220 is on an upper surface of the bottom plate of the bottom chassis 210 to reflect the light generated from the lamp 230. As shown in FIGS. 1 to 3, the reflecting plate 220 is of a flat type. In other embodiments, the reflecting plate 220 may have a base reflecting surface and a protrusion on the base reflecting surface, or a base reflecting surface and a groove on the base reflecting surface. In yet other embodiments, a reflective material that has a high reflectivity may be coated on the bottom surface of the bottom chassis 210, allowing the reflecting plate 220 to be omitted.

The lamp 230 is guided by the side mold unit 110, and the lamp 230 is also guided and supported by the lamp guide unit 240. The lamp 230 is on the reflecting plate 220. As shown in FIGS. 1 to 3, the lamp 230 has a U-shape. Alternatively, the lamp 230 may have various shapes, such as an I-shape, an N-shape, an M-shape, an S-shape, etc.

The lamp guide unit 240 includes a first lamp holder 242, a second lamp holder 244 and a lamp supporter 246, and partially covers the lamp 230. The lamp 230 is spaced apart from the reflecting plate 220 by the lamp guide unit 240 at a constant distance. The first lamp holder 242 receives the end portions of the lamp 230, and receives wires through which an electric voltage is applied to the end portions of the lamp 230. The second lamp holder 244 is on a bending portion of the lamp 230 and supports the lamp 230. The lamp supporter 246 is located between the first and second lamp holders 242 and 244. The lamp supporter 246 supports the lamp 230. In particular, the lamp 230 is spaced apart from the reflecting plate 220 by the first and second lamp holders 242 and 244 and the lamp supporter 246 at a constant distance.

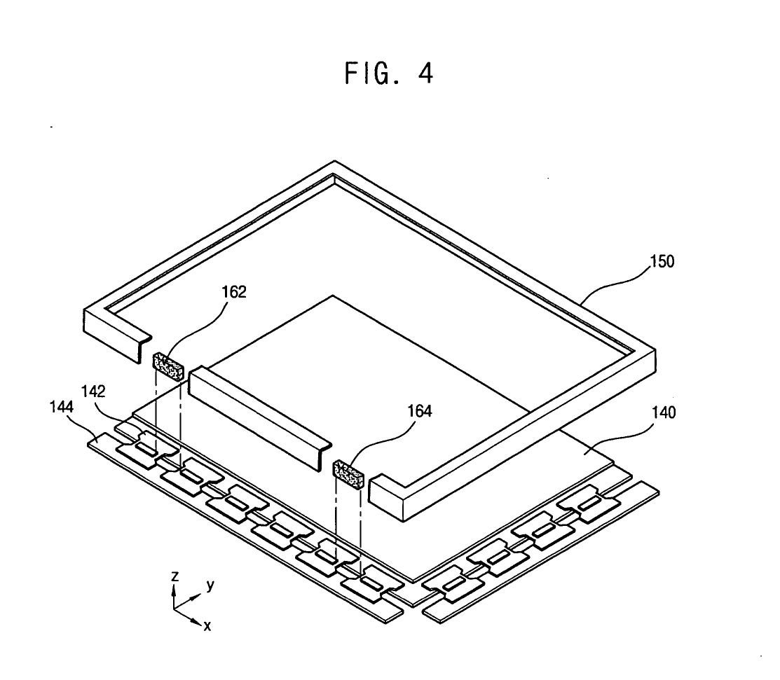

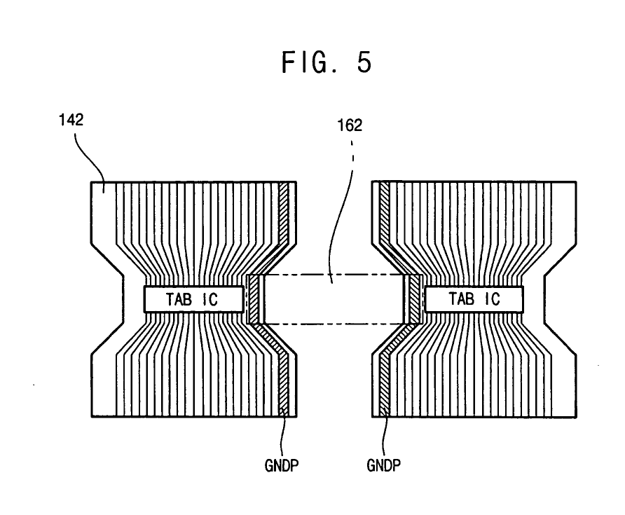

FIG. 4 is an exploded perspective view showing a conductive compressible body disposed between a panel assembly and a top chassis of the flat panel display device of FIG. 1. FIG. 5 is a plan view showing a conductive compressible body that makes contact with a ground pattern of a flexible printed circuit board (FPCB) of the flat panel display device of FIG. 1.

Referring to FIGS. 4 and 5, the first gasket 162 and the second gasket 164 are on an inner surface of the top chassis 150, and electrically connect the top chassis 150 to the ground pattern GNDP that is formed on the FPCB 142.

An area of the ground pattern GNDP is increased so that contact characteristics between the ground pattern GNDP and the top chassis 150 are improved. In this embodiment, an exposed area of the ground pattern GNDP is larger than an area of a line that is electrically connected to the TAB IC.

As shown in FIGS. 4 and 5, the first gasket 162 contacts two neighboring data FPCBs that are at one end portion of the data PCB 144, and the second gasket 164 corresponds to two neighboring data FPCBs that are at another end portion of the data PCB 144. In an alternative embodiment, one gasket or three gaskets may be contacting two neighboring data FPCBs. In some embodiments, a gasket may be on two neighboring gate FPCBs located on one end portion of the gate PCB 144.

The first and second gaskets 162 and 164 are compressed by the top chassis 150 and make contact with the ground pattern GNDP. Thus, the ground pattern formed on the array substrate is electrically connected to the ground pattern formed on the data PCB 144 through the ground pattern GNDP. The ground pattern GNDP is formed in a region on which a TAB IC is not mounted. The FPCB 142 is electrically connected to the top chassis 150 through the first and second gaskets 162 and 164.

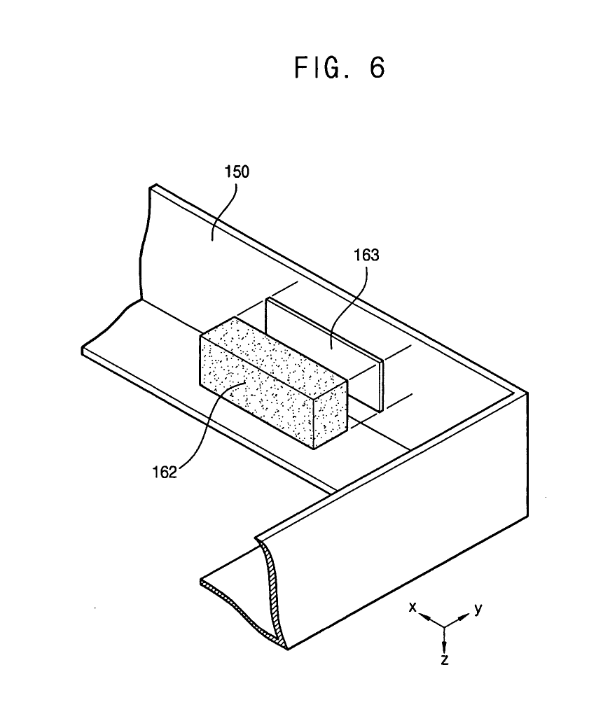

FIG. 6 is a partially cut out perspective view showing a conductive compressible body that is attached to the top chassis of FIG. 4.

Referring to FIG. 6, the first gasket 162 is attached to the inner surface of the top chassis 150 through a conductive tape 163. The conductive tape 163 has first and second adhesive layers having conductive particles, the first and second adhesive layers are on two surfaces. The first gasket 162 is attached to the inner surface of the top chassis 150 through the conductive tape 163, and is electrically connected to the top chassis 150 through the conductive tape 163.

According to this embodiment, the top chassis 150 has the first and second gaskets 162 and 164 that are attached to the inner surface of the top chassis 150. The top chassis 150 is combined with an LCD module. A conductive material is coated on the surfaces of the first and second gaskets 162 and 164, which are compressible like a sponge. Accordingly, the top chassis 150 is electrically connected to the ground pattern GNDP of the FPCB having the TAB packaging structure through the first and second gaskets 162 and 164. By using the first and second gaskets 162, 164, a fabricating process of the flat panel display device is simplified. An area of the ground pattern GNDP is increased to improve contact characteristics between the ground pattern GNDP of the FPCB and the top chassis 150. In addition, an exposed area of a copper (Cu) layer is greatly increased so that the contact characteristics between the ground pattern GNDP of the FPCB and the top chassis 150 are improved.

### Embodiment 2

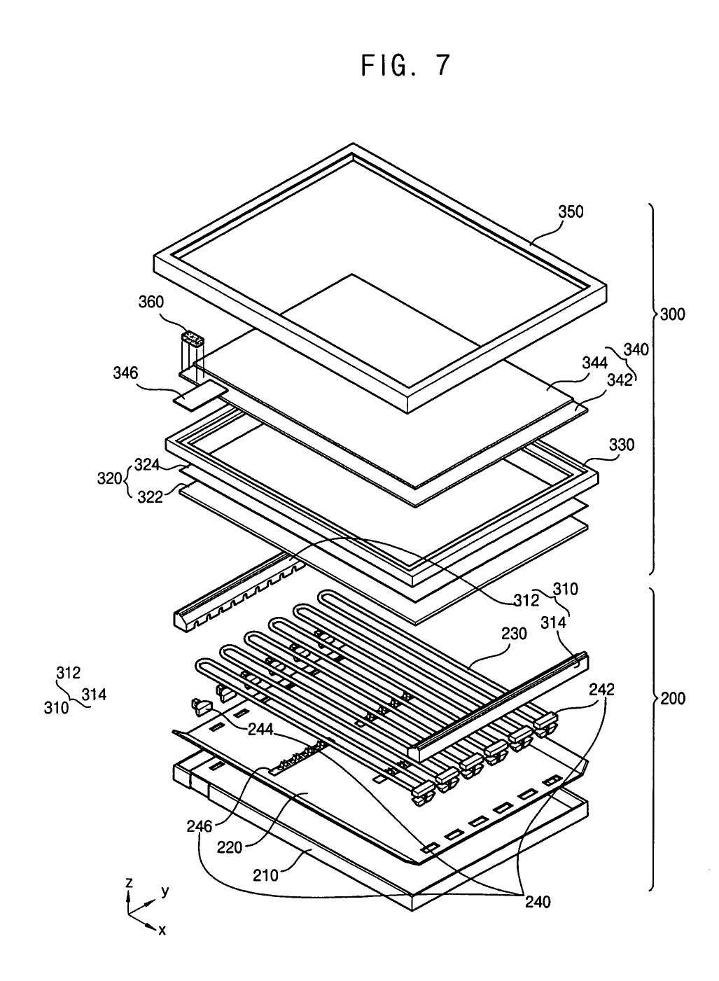

FIG. 7 is an exploded perspective view showing a flat panel display device according to a second embodiment of the present invention. The flat panel display device is of the chip on glass (COG) type.

Referring to FIG. 7, the flat panel display device includes a display panel assembly 300 and a backlight assembly 200 under the display panel assembly 300. In FIG. 7, the same reference numerals will be used to refer to the same or like parts as those described in FIG. 1 and any further explanation concerning the above elements will be omitted.

The display panel assembly 300 includes a side mold unit 310, a brightness enhancing unit 320, an upper mold unit 330, a flat panel 340, a top chassis 350 and a conductive compressible body 360, and receives the light generated from the backlight assembly 200 to display an image.

The side mold unit 310 includes a first side mold 312 and a second side mold 314. The side mold unit 310 guides the backlight assembly 200, and supports the brightness enhancing unit 320. The first and second side molds 312 and 314 guide the lamps 230 through a plurality of holes formed in a lower portion of the first and second side molds 312 and 314, and support the brightness enhancing unit 320 through a stepped portion formed in the upper parts of the first and second side molds 312 and 314.

The brightness enhancing unit 320 includes a diffusion plate 322 and optical sheets 324 formed on the diffusion plate 322. The brightness enhancing unit 320 is on the side mold unit 310. The brightness enhancing unit 320 uniformizes the brightness of the light that is incident on a lower surface of the brightness enhancing unit 320, and the light that has passed through the brightness enhancing unit 320 exits an upper surface of the brightness enhancing unit 320 and advances toward the flat panel 340. The diffusion plate 322 and the optical sheets 324 are on a stepped portion of the first side mold 312 and a stepped portion of the second side mold 314.

The upper mold 330 is shaped like a frame and supports an edge of the flat panel 340. The upper mold 330 receives the flat panel 340. The upper mold 330 is combined with the side mold unit 310 to prevent drifting of the brightness enhancing unit 320. The brightness enhancing unit 320 includes the diffusion plate 322 and the optical sheets 324 on the diffusion plate 322. The optical sheets 324 may include a diffusion sheet, prism sheets, a protective sheet, etc.

The flat panel 340 includes an array substrate 342, a color filter substrate 344, and a liquid crystal layer between the array substrate 342 and the color filter substrate 344. The flat panel 340 is on the upper mold unit 330, and receives the light emitted from the backlight assembly 200 to display an image using electric and optical characteristics of the liquid crystals in the liquid crystal layer.

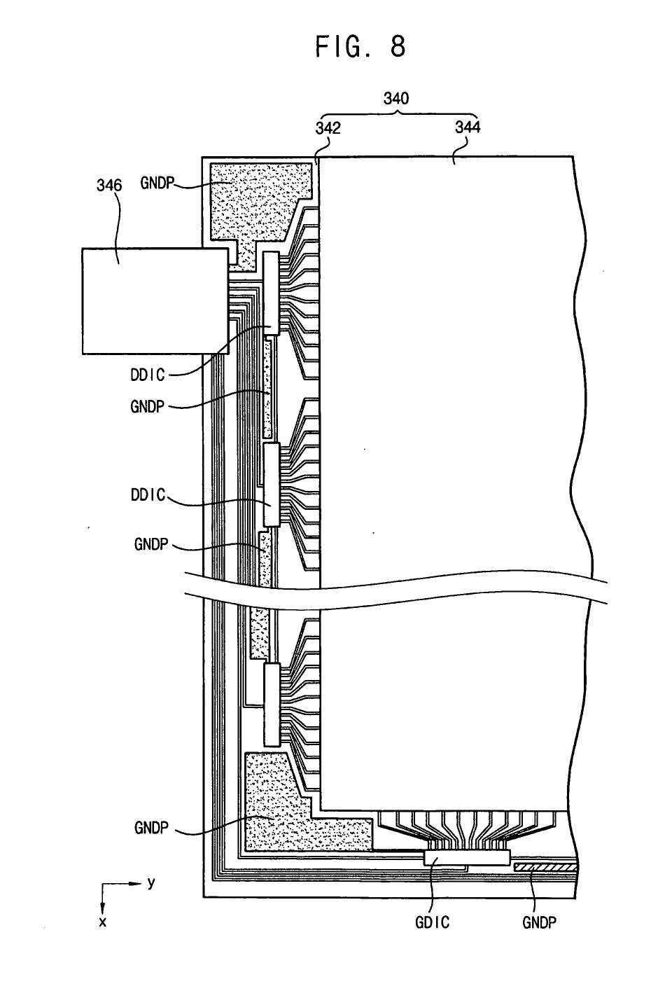

FIG. 8 is a plan view showing a plurality of conductive patterns on the array substrate and a ground pattern of FIG. 7.

Referring to FIG. 8, a plurality of gate lines, a plurality of data lines and a thin film transistor are formed on an effective display area of the array substrate 342. The thin film transistor is electrically connected to one of the gate lines and one of the data lines. A plurality of data driver ICs DDICs that transmit image signals to the data lines is mounted on a peripheral area of the array substrate 342 adjacent to a side of the array substrate 342. A plurality of gate driver ICs GDICs that transmit gate signals to the gate lines is mounted on the peripheral area of the array substrate 342 adjacent to another side of the array substrate 342.

The flat panel 340 is electrically connected to the FPCB 346. The flat panel 340 receives a plurality of signals to display the image. The signals are outputted from an external control PCB to display the image. The signals may include an image signal, a plurality of synchronization signals, a clock signal, etc. A plurality of conductive paths through which the signals are applied to the flat panel 340 is formed on the FPCB 346.

The gate driver IC GDIC that is electrically connected to end portions of the gate lines is electrically connected to the FPCB 346 through a conductive path that is formed on the array substrate 342. The date driver IC DDIC that is electrically connected to end portions of the data lines is electrically connected to the FPCB 346 through a connective path that is formed on the array substrate 342. Adjacent gate driver ICs GDICs are electrically connected to each other, and various clock signals or various voltages are typically applied to the adjacent gate driver ICs GDICs. Adjacent data driver ICs DDICs are electrically connected to each other, and various clock signals or various voltages are applied to the adjacent data driver ICs DDICs. A plurality of the ground patterns GNDP is formed on a region on which the conductive path is not formed. For example, one end portion of the ground pattern GNDP is electrically connected to the FPCB 346, and another end portion of the ground pattern GNDP is electrically connected to the top chassis 350 through the conductive compressible body 360.

The top chassis 350 has a picture frame shape, and is combined with the upper mold 330 to prevent drifting of the flat panel 340.

The conductive compressible body 360 is on the ground pattern GNDP that is formed on the peripheral area of the array substrate 342 of the chip on glass (COG) type flat panel 340.

The back light assembly 200 is the same as in FIG. 1. Thus, the same reference numerals will be used to refer to the same or like parts as those described in FIG. 1 and any further explanation concerning the above elements will be omitted.

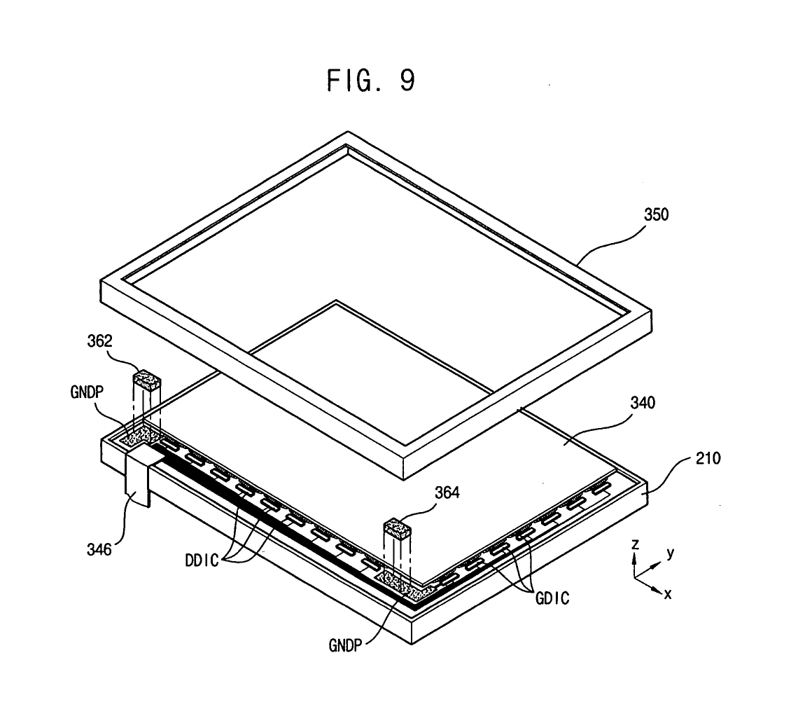

FIG. 9 is an exploded perspective view showing a conductive compressible body disposed between a panel assembly and a top chassis of FIG. 7.

Referring to FIGS. 7 to 9, a first gasket 362 and a second gasket 364 are attached to an inner upper surface of the top chassis 350, and electrically connect between the top chassis 350 and the ground pattern GNDP that is formed on the flexible printed circuit board 346. The area of the ground pattern GNDP is increased so that contact characteristics between the ground pattern GNDP and the top chassis are improved. In this embodiment, an exposed area of the ground pattern GNDP is greatly increased.

As shown in FIG. 9, the first and second gaskets 362 and 364 are on ground patterns GNDP, respectively. In alternative embodiments, one gasket or three gaskets may be on two neighboring data FPCBs. In some embodiments, one gasket may be on two neighboring gate FPCBs that are located on one end portion of a gate PCB.

The widest surfaces of each of the first and second gaskets 362 and 364 are parallel to the x-y plane, and the first and second gaskets 362 and 364 are compressed by the top chassis 350. This way, the first and second gaskets 362 and 364 make contact with the ground pattern GNDP. Therefore, the ground pattern GNDP formed on the array substrate 342 having a COG structure is electrically connected to the top chassis 150 through the first and second gaskets 362 and 364.

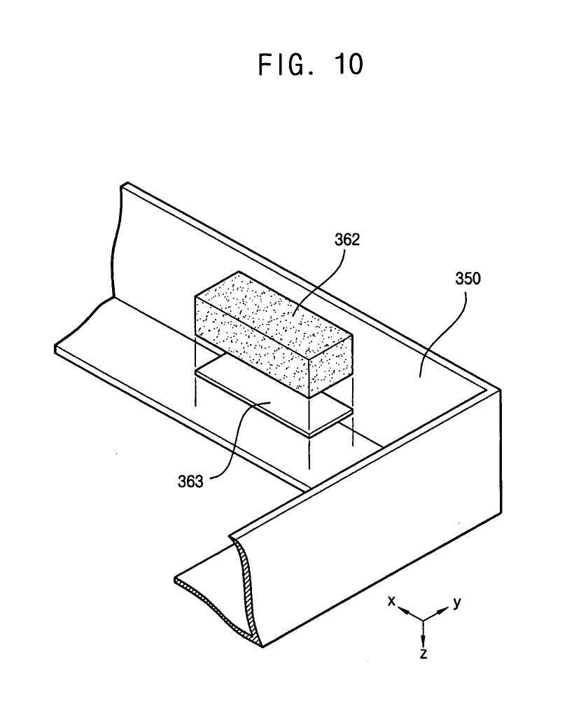

FIG. 10 is a partially cut out perspective view showing a conductive compressible body that is attached to the top chassis of FIG. 9.

Referring to FIG. 10, the first gasket 362 is attached to an upper surface of the top chassis 350 through a conductive tape 363. The conductive tape 363 has first and second adhesive layers having conductive particles. The conductive tape 363 has the first and second adhesive layers on two surfaces of the conductive tape 363. The first gasket 361 is attached to the upper surface of the top chassis 350 through the conductive tape 363, and is electrically connected to the top chassis 350 through the conductive tape 363.

According to this embodiment, the top chassis 350 has the first and second gaskets 362 and 364 that are attached to the upper surface of the top chassis 350. The top chassis 350 is combined with an LCD module. Each of the first and second gaskets 362 and 364 includes the conductive material that is coated on its surface and is compressible like a sponge. Accordingly, the top chassis 350 is electrically connected to the ground pattern GNDP of the array substrate 342 having the COG structure through the first and second gaskets 362 and 364. The area of the ground pattern GNDP is increased to improve contact characteristics between the ground pattern GNDP of the FPCB and the top chassis 350. In addition, an exposed area of a copper layer is greatly increased so that the contact characteristics between the ground pattern GNDP of the array substrate 342 and the top chassis 350 are improved.

According to the present invention, the top chassis having the gasket that is attached to the inner surface of the top chassis is combined with the LCD module. A conductive material is coated on the surface of the gasket, which is compressible like the sponge. Accordingly, the top chassis is electrically connected to the ground pattern of the FPCB having the TAB packaging structure through the gasket without any additional process. Therefore, a fabricating process of the flat panel display device is simplified.

In addition, the top chassis 350 having the gasket attached to its inner upper surface is combined with the LCD module. A conductive material is coated on the surface of the gasket, which is compressible like the sponge. Accordingly, the top chassis is electrically connected to the ground pattern formed on the array substrate having the COG structure through the gasket without any additional process. By using the conductive compressible gasket, the fabricating process of the flat panel display device is simplified.

Furthermore, the gasket can be used in a grounding process of the LCD module so that a screw or an aluminum tape may be omitted.

This invention has been described with reference to the embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A flat panel display device comprising:
a receiving unit for receiving a flat panel;
a substrate having a ground pattern and a driving circuit that applies a signal to the flat panel to display an image; and
a conductive compressible body for electrically connecting the ground pattern of the substrate to the receiving unit.

2. The flat panel display device of claim 1, wherein the conductive compressible body is a gasket, and the gasket comprises conductive particles and a conductive material that is coated on the conductive particles.

3. The flat panel display device of claim 1, wherein the substrate comprises a base film and a plurality of conductive paths that are formed on the base film, and the ground pattern is exposed so that the ground pattern is electrically connected to the conductive compressible body.

4. The flat panel display device of claim 3, wherein the signal to display the image includes a data signal, a clock signal and a power voltage, and wherein
the conductive paths comprise a data line transferring the data signal, a clock line transferring the clock signal, and a voltage line transferring the power voltage, and
the ground pattern that is electrically insulated from the data line, the clock line and the voltage line is formed from a same layer as the data line, the clock line and the voltage line.

5. The flat panel display device of claim 1, further comprising a conductive adhesive layer between the receiving unit and the conductive compressible body.

6. The flat panel display device of claim 1, wherein a widest surface of the conductive compressible body is on the flat panel and an upper surface of the receiving unit.

7. The flat panel display device of claim 1, wherein a widest surface of the conductive compressible body is on an inner surface of the receiving unit.

8. A flat panel display device comprising:
a flat panel for displaying an image;
a first receiving unit for receiving the flat panel;
a substrate having a ground pattern and a driving circuit that applies a signal to the flat panel to display the image; and
a conductive compressible body for electrically connecting the ground pattern of the substrate to the first receiving unit.

9. The flat panel display device of claim 8, wherein the flat panel comprises an array substrate having a plurality of gate lines, a plurality of data lines and a thin film transistor (TFT) on an area defined by the gate and data lines adjacent to each other, and each of the gate lines comprises a gate pad that is electrically connected to a conductive path of the substrate adjacent to an end portion of the gate line.

10. The flat panel display device of claim 8, wherein the flat panel comprises an array substrate having a plurality of gate lines, a plurality of data lines and a thin film transistor (TFT) in an area defined by the gate and data lines adjacent to each other, and each of the data lines comprises a data pad that is connected to a conductive path of the substrate adjacent to an end portion of the data line.

11. The flat panel display device of claim 8, wherein the substrate is a flexible printed circuit board (FPCB), and the ground pattern is a conductive path that is patterned on the flexible printed circuit board.

12. The flat panel display device of claim 8, wherein the first receiving unit is a frame including an opening, and an effective display area of the flat panel is exposed through the opening of the picture frame shape.

13. The flat panel display device of claim 8, further comprising a second receiving unit having a bottom plate and a plurality of inner walls extending from the bottom plate for receiving the flat panel, wherein the first receiving unit covers the inner walls of the second receiving unit to receive the flat panel, and the conductive compressible body is on an inner surface of the first receiving unit to be electrically connected to the ground pattern.

14. The flat panel display device of claim 13, wherein the first receiving unit comprises a plurality of sidewalls connected to one another and a protrusion for guiding the flat panel extending from edge portions of the sidewalls, and the conductive compressible body is on an inner surface of one of the sidewalls.

15. A flat panel display device comprising:
a flat panel having an effective display area and a peripheral area;
a receiving unit for receiving the flat panel;
a driving circuit formed on the peripheral area for applying a signal for displaying an image to the effective display area through a conductive path; and
a conductive compressible body for electrically connecting a ground pattern formed on the peripheral area to the first receiving unit.

16. The flat panel display device of claim 15, wherein the flat panel comprises an array substrate having a plurality of gate lines, a plurality of data lines and a thin film transistor (TFT) on an area defined by the gate and data lines adjacent to each other, and wherein an end portion of each of the gate lines is electrically connected to an output line of the driving circuit.

17. The flat panel display device of claim 15, wherein the flat panel comprises an array substrate having a plurality of gate lines, a plurality of data lines and a thin film transistor (TFT) on an area defined by the gate and data lines adjacent to each other, and an end portion of each of the data lines is electrically connected to an output line of the driving circuit.

18. The flat panel display device of claim 15, wherein the signal to display the image comprises a data signal, a clock signal and a power voltage,
the conductive paths comprise a data line transferring the data signal, a clock line transferring the clock signal, and a voltage line transferring the power voltage, and
the ground pattern that is electrically insulated from the data line, the clock line and the voltage line is formed from a same layer as the data line, the clock line and the voltage line.

19. The flat panel display device of claim 15, further comprising a second receiving unit having a bottom plate and a plurality of inner walls extending from the bottom plate for receiving the flat panel,
wherein the first receiving unit is a frame having an opening through which an effective display area of the flat panel is exposed to cover the inner walls of second receiving unit to receive the flat panel, and the conductive compressible body is on an inner surface of the first receiving unit to be electrically connected to the ground pattern.

20. The flat panel display device of claim 19, wherein the first receiving unit comprises a plurality of sidewalls connected to one another and a protrusion for guiding the flat panel extended from an edge potion of the sidewalls, and the conductive compressible body is on a inner surface of one of the sidewalls.
